(19) United States
(12) Patent Application Publication
(10) Pub. No.: US 2006/0056398 A1
(43) Pub. Date: Mar. 16, 2006

(54) Telecommunication system and method for operating the same

(75) Inventors: Volker Wilkening, Bordesholm (DE); Udo Rehse, Berlin (DE)

Correspondence Address: LERNER GREENBERG STEMER LLP, P O BOX 2480, HOLLYWOOD, FL, 33022-2480, US

(73) Assignee: DeTeWe Systems GmbH

(21) Appl. No.: 11/242,583

(22) Filed: Oct. 3, 2005

(30) Foreign Application Priority Data
Dec. 15, 2003 (DE) 103 58 995.3

(51) Int. Cl. H04L 12/66

(52) U.S. Cl. 370/352

(57) ABSTRACT

A telecommunication system and a method for operating the same have at least one connection for a public telecommunication network and at least one connection for a telecommunication terminal. In order to obtain a particularly high degree of user friendliness, the telecommunication system has at least one network connection at which at least two computer devices can be connected, and a control device which operates the network connection in such a manner that voice data can be transmitted bidirectionally between the telecommunication system and the at least two computer devices. The voice data transmission permits each connected computer device to be operated as a telephone and/or as a fax device. The control device permits at least one separate telephone number to be allocated to each connected computer device.

### BACKGROUND OF THE INVENTION

Field of the Invention

The invention relates to a telecommunication system, which is also known as a “TC system” in technical jargon, having at least one connection for a public telecommunication network and having at least one connection for a telecommunication terminal. The invention also relates to a method for operating the telecommunication system. Such prior art systems and methods have not been very user-friendly.

### SUMMARY OF INVENTION

It is accordingly an object of the invention to provide a telecommunication system and a method for operating the same, which overcome the hereinafore-mentioned disadvantages of the heretofore-known systems and methods of this general type and which achieve a particularly high degree of user friendliness.

With the foregoing and other objects in view there is provided, in accordance with the invention, a telecommunication system, comprising at least one connection for a public telecommunication network and at least one connection for a telecommunication terminal. At least one respective network connection or LAN (Local Area Network) connection is provided to which at least two computer devices can be connected “simultaneously”. A control device operates the network connection in such a manner that voice data can be transmitted bidirectionally between the telecommunication system and the at least two computer devices. The voice data transmission is provided in such a manner that each of the connected computer devices can be operated as a telephone and/or as a fax device. The control device causes at least one separate telephone number to be allocated to each connected computer device in each case.

An important advantage of the telecommunication system according to the invention resides in the fact that, due to the network or LAN connection (Local Area Network), a number of computer devices can be connected to the telecommunication system and thus indirectly to the public telecommunication network as well, without each computer device needing a separate modem for this purpose. That is because the telecommunication system provides a network connection as a substitute.

A further important advantage of the telecommunication system according to the invention resides in the fact that the computer devices connected to the telecommunication system can also be operated as conventional telephones or conventional fax devices. In the telecommunication system according to the invention, this is achieved due to the fact that between the connected computer devices and the telecommunication system, in each case voice data can be transmitted in such a manner that a telephone or fax operation is possible. Such a conventional “telephone operation” is guaranteed by a suitable data format which is understood both by the telecommunication system and by the connected computer devices. The way in which the data format is provided in real terms is virtually arbitrary.

A third important advantage of the telecommunication system according to the invention can be seen in the fact that each computer device connected to the telecommunication system additionally can also be addressed and called from the outside like a conventional telephone or fax device. That is because in each case a separate telephone number can be allocated to each computer device.

A fourth important advantage of the telecommunication system according to the invention resides in the fact that a multiplicity of computer devices can be simultaneously connected to the telecommunication system and can communicate with one another and with the telecommunication system through the network or “LAN”. Thus, a point-to-multipoint connection instead of a simple point-to-point connection is provided.

In accordance with another feature of the invention, a particularly suitable network is formed, for example, by the ETHERNET network. It is thus advantageous if the at least one network connection is an ETHERNET network connection which is operated in ETHERNET mode by the control device.

In accordance with a further feature of the invention, in order to ensure that the voice data, that is to say the “telephone call data” and/or the “fax data” are transmitted virtually without delay so that the user has the impression that it is a “permanent line”, it is advantageous if the voice data are transmitted transparently or “bit-transparently”, respectively. In order to achieve this transparent transmission, it is only important that an adequate data rate of at least 64 Kbit/s is guaranteed.

In accordance with an added feature of the invention, it is particularly advantageous if the control device additionally generates and sends wake-up signals through the respective network or LAN. The wake-up signal can, for example, advantageously be a so-called “wake-up-on-LAN-signal”. Such a wake-up signal makes it possible for the computer devices to be operated permanently in a power-saving mode or sleep mode and at the same time still remain accessible from the outside like a “telecommunication terminal”. This is because, as soon as a telephone call which is intended for one of the connected computer devices is received in the telecommunication system, the control device will generate a wake-up signal in order to wake the computer device concerned from its sleep mode and activate it. At the computer end, this only requires that the connected computer devices regularly monitor their network connection for the presence of such a wake-up signal even in sleep mode and, if necessary, activate themselves.

In accordance with an additional feature of the invention, the at least one connection of the telecommunication system for the public telecommunication network is preferably an ISDN connection. That is because ISDN connections make it possible, among other things, to simultaneously connect a number of telecommunication terminals.

In accordance with yet another feature of the invention, it is advantageous if the telecommunication system, in addition to the ISDN connection or as an alternative to the ISDN connection, has a DSL connection and/or a connection for cable television, abbreviated below as a “cable connection”, through the use of which the telecommunication system can be additionally connected to the public communication network. This is because it is possible to transmit data at a very high data rate through a DSL (Digital Subscriber Line) connection or through a cable connection, as a result of which, for example, the waiting time is greatly reduced for computer devices connected to the telecommunication system when the Internet is used.

In accordance with yet a further feature of the invention, the DSL connection can, for example, be an ADSL (Asymmetric Digital Subscriber Line) connection.

In accordance with yet an added feature of the invention, it is advantageous if the telecommunication system has a modem or is connected to an external modem which, on one hand, is connected to the at least one network connection and, on the other hand, to the DSL connection or the cable connection. Such a modem ensures that the data transmission method in the DSL or cable line system is adapted to the data transmission system of the network or LAN of the telecommunication system. The external connection of the modem then forms the external DSL or cable connection of the telecommunication system.

In accordance with yet an additional feature of the invention, a switching device, particularly a so-called “switch” is disposed between the modem and the network connection of the telecommunication system, on one hand, and the computer devices and the modem, on the other hand. This switching device provides for a connection between the telecommunication system and the modem, on one hand, and for a connection between the computer devices and the telecommunication system, on the other hand. Such a respective switching device or switch also makes it possible for the computer devices connected to the telecommunication system to use the telecommunication system as a “router” and, through the telecommunication system operating as a “router”, access the modem connected to the telecommunication system and thus the DSL line or the cable connection.

In accordance with again another feature of the invention, in order to support such an access to the telecommunication system, the telecommunication system preferably has an additional router.

In accordance with again a further feature of the invention, the router advantageously has a DHCP server for automatically issuing IP network addresses and/or a firewall function.

In accordance with again an added feature of the invention, at least one of the computer devices can be connected to the LAN connection of the telecommunication system through a radio link. This is because, if the telecommunication system has such a radio interface, a computer device can be brought into a telephone or data connection with the telecommunication system without requiring a wire connection. The computer device is thus “mobile”.

In accordance with still another feature of the invention, the radio interface is advantageously formed by a card slot connected to the network or LAN, into which a mobile radio card can be removeably inserted. If the telecommunication system has such a card slot, a radio operation with different radio standards can be selected by exchanging the mobile radio cards.

In accordance with still a further feature of the invention, the mobile radio card can, for example, be a so-called “compact flash card”.

In accordance with still an added feature of the invention, the card slot is preferably a CF II slot, since such a slot can be “hot-plug-capable”, i.e. can be brought into operation without the telecommunication system first having to be deactivated.

In accordance with still an additional feature of the invention, the mobile radio card operates in accordance with the DECT standard. The DECT radio standard has proven successful for transmitting voice and data signals.

In accordance with another feature of the invention, as an alternative, the mobile radio card can also operate in accordance with the WiFi standard so that a multiplicity of computer devices can simultaneously enter into a “cable-free” data link with the telecommunication system.

With the objects of the invention in view, there is also provided a method for operating a telecommunication system. The method comprises connecting at least two computer devices to a network connection of the telecommunication system. Voice data is bidirectionally transmitted between the telecommunication system and the at least two computer devices, for permitting each of the at least two computer devices connected to the telecommunication system to be operated as a telephone and/or as a fax device. At least one separate telephone number is allocated to at least one of the at least two connected computer devices. In this respect, the invention is based on the object of achieving a particularly high degree of user friendliness.

In accordance with another mode of the invention, a plurality of computer devices, that is at least two computer devices, is connected to the telecommunication system through at least one network connection (LAN connection). Voice data are transmitted bidirectionally through the network between the telecommunication system and the computer devices so that each connected computer device can be operated as a telephone and/or as a fax device.

In accordance with a concomitant mode of the invention, at least one separate telephone number is in each case allocated to each connected computer device so that direct accessibility is ensured from the outside as well, that is to say for external “callers” calling through the public telecommunication network or for internal “callers” connected to the telecommunication system.

With respect to the advantages of the method according to the invention, reference is made to the advantages of the telecommunication system (TC system) according to the invention, since the advantages of the telecommunication system substantially correspond to the advantages of the method according to the invention.

Naturally, it is also possible for the computer devices connected to the LAN connection to communicate with one another or, respectively, with the DSL or cable network or Internet or alternatively in other data or signal formats than with the telecommunication system.

Other features which are considered as characteristic for the invention are set forth in the appended claims.

Although the invention is illustrated and described herein as embodied in a telecommunication system and a method for operating the same, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a block circuit diagram of a first exemplary embodiment of a telecommunication system according to the invention with an external modem and an external switch; and

FIG. 2 is a block circuit diagram of a second exemplary embodiment of a telecommunication system according to the invention with an integrated modem and an external switch.

### DESCRIPTION OF THE PREFERRED EMBODIMENTS

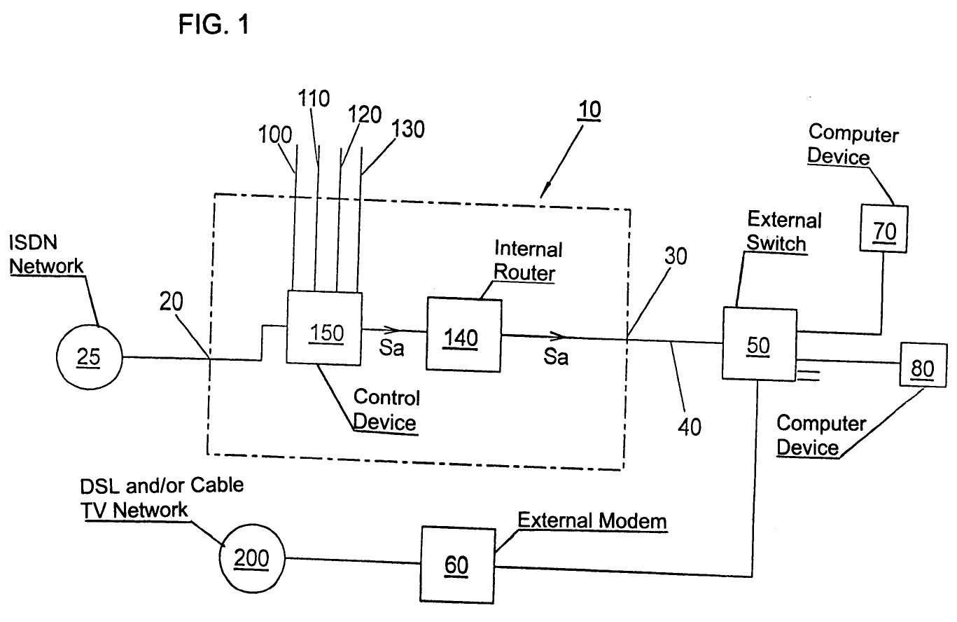

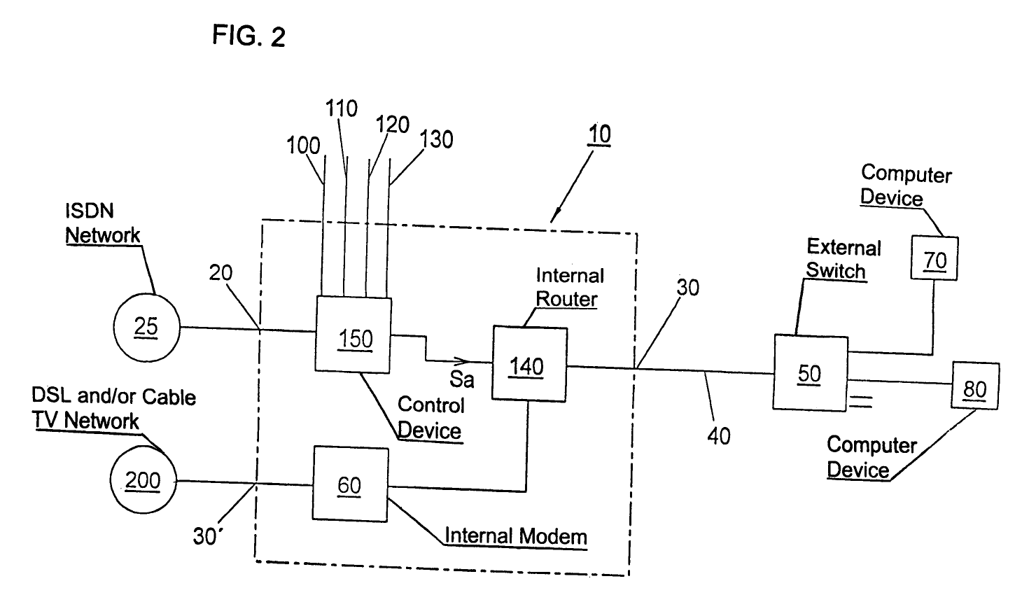

Referring now to the figures of the drawings in detail, it is noted that the method according to the invention can be performed with each of the telecommunication systems shown in FIGS. 1 and 2 and that the same reference symbols are used for identical or comparable components in FIGS. 1 and 2.

FIG. 1 illustrates a telecommunication system 10 with a connection 20 for a public telecommunication network. The connection 20 is an ISDN connection through the use of which the telecommunication system 10 is connected to an ISDN network 25.

The telecommunication system 10 also has a network connection 30 through the use of which a LAN network 40 is connected to the telecommunication system 10. The LAN network 40 is an ETHERNET network.

The LAN network 40 is respectively connected to a switching device or an external “switch” 50 which, on one hand, is connected to an external modem 60 and, on the other hand, is connected to a multiplicity of computer devices, of which only two computer devices 70 and 80 are shown in FIG. 1 for the sake of clarity.

In addition, the telecommunication system 10 has four analog connections 100, 110, 120 and 130, through the use of which conventional analog or digital telecommunication terminals can be connected to the telecommunication system 10.

The telecommunication system 10 also has an internal router 140 which is connected to the ETHERNET network 40. The router 140 is connected to a control device 150 which is connected to the ISDN connection 20 and thus to the ISDN network 25, and is connected to the four analog connections 100, 110, 120 and 130.

The modem 60 forms a connection to a DSL and/or cable network (cable television network) 200.

The configuration according to FIG. 1 is operated as follows:

Each computer device 70 and 80 connected through the LAN network 40 is allocated its own telephone number by the control device 150 of the telecommunication system 10. It is thus possible to call the computer devices 70 or 80 directly through the ISDN network 25, that is to say from “externally”, in order to transmit voice data, that is to say “telephone call data” and/or “fax data” to the computer device 70 or 80 or conversely.

The connection between the computer devices 70 and 80 and the ISDN network is provided by the control device 150, the router 140 and the switch 50.

By allocating the directory numbers to the computer devices 70 and 80, it is also possible for the computer devices 70 and 80, as telecommunication terminals, to exchange voice data with one another as well as with “internal” telecommunication terminals which are connected to the four analog telecommunication connections 100, 110, 120 and 130. Thus, an “internal” “voice data operation” is also possible. The internal voice data operation is exclusively managed by the switch 50 in the case of a voice data transmission between the computer devices 70 and 80. In the case of an internal voice data transmission between one of the computer devices 70 and 80 and an internal telecommunication terminal connected to one of the connections 100 to 130, the call is also switched through the router 140 and the control device 150.

In addition, the computer devices 70 and 80 can access the modem 60, and thus the DSL or cable network 200 connected to the modem 60, through the switching device or the switch 50, in order to connect in the usual manner, for example, to the Internet. For this purpose, the switch 50 connects the computer devices 70 and 80 to the router 140 which, in turn, establishes the connection with the modem 60 and thus with the DSL or cable network 200.

In summary, it is thus possible to operate the computer devices 70 and 80 like conventional telecommunication terminals in order to feed, for example, telephone call data or fax information into the ISDN network 25 through the LAN network 40. In addition, it is possible to access each of the computer devices 70 and 80 directly through the ISDN network 25 because a separate directory number is in each case allocated to each computer device 70 and 80. In addition, each computer device 70 and 80 can also access the router 140 through the switching device 50 in order to obtain a connection to the DSL network or cable network 200, and thus the Internet, in the usual manner. Furthermore, an internal voice data transmission between computer devices 70 and 80 with one another and between computer devices and telecommunication terminals at the connections 100 to 130, is possible.

The LAN network 40 thus provides a “point-to-multipoint” connection through the use of which a plurality of computer devices can be connected to the telecommunication system 10.

In addition, the respective telecommunication system 10 or control device 150 provides a wake-up mode in order to generate wake-up signals Sa for the computer devices 70 and 80 connected to the LAN network 40. Such wake-up signals which are, for example, “wake-up-on-LAN” signals, make it possible to operate the computer devices 70 and 80 in a sleep mode or power saving mode. In this sleep mode or power saving mode, the computer devices 70 and 80 are substantially deactivated. The computer devices only monitor the LAN network 40 for the presence of the wake-up signals, which may have been generated by the telecommunication system 10, in order to reactivate themselves.

The telecommunication system 1Q preferably generates such wake-up signals only when a telephone call is received from the ISDN network 25 or from internal callers, that is to say from the telecommunication terminals connected to the connections 100 to 130 or other computer devices connected to the LAN network. The call is associated with one of the connected computer devices 70 or 80 through the directory number allocation within the control device 150.

In addition, the computer devices 70 and 80 can also generate wake-up signals when they wish to communicate with another computer device and, for example, to exchange voice data directly.

Incidentally, the switch 50 can also be connected to the computer devices 70 and 80 through a radio link. The radio interface is formed, for example, by a card slot into which a mobile radio card is removeably inserted. The card slot is connected to one of the computer connections of the switch 50.

FIG. 2 illustrates an exemplary embodiment of a telecommunication system 10 with two network connections 30 and 30′.

A LAN network 40, for example an ETHERNET network, is connected to the telecommunication system 10 at one network connection 30. A router 140 of the telecommunication system 10 and an external switch 50 are connected to the one network connection 30. Computer devices 70 and 80 are connected to the switch 50.

An internal modem 60 disposed in the telecommunication system 10 and an external DSL or cable network 200 are connected to the other network connection 30′. The router 140 is connected to the modem 60.

With respect to the operating mode, reference is made to the above statements made in connection with FIG. 1 since the telecommunication system 10 according to FIG. 2 can be operated like the telecommunication system 10 according to FIG. 1.

We claim:

1. A telecommunication system, comprising:
at least one connection for a public telecommunication network;
at least one connection for a telecommunication terminal;
at least one network connection for at least two computer devices; and
a control device operating said at least one network connection to permit voice data to be transmitted bidirectionally between the telecommunication system and the at least two computer devices, the voice data transmission permitting each of the at least two computer devices to be operated as a telephone and/or as a fax device, and said control device permitting at least one separate telephone number to be allocated to each of the at least two computer devices.

2. The telecommunication system according to claim 1, wherein said at least one network connection is an ETHERNET network connection operated in ETHERNET mode by said control device.

3. The telecommunication system according to claim 1, wherein said control device causes the voice data to be transmitted transparently.

4. The telecommunication system according to claim 1, wherein said control device generates wake-up signals and sends the wake-up signals through said at least one network connection at least to one of the at least two computer devices called by a caller.

5. The telecommunication system according to claim 4, wherein the caller is an external or an internal caller.

6. The telecommunication system according to claim 1, wherein the at least one connection for the public telecommunication network is an ISDN connection or an analog access.

7. The telecommunication system according to claim 1, which further comprises at least one DSL or cable connection.

8. The telecommunication system according to claim 7, wherein said DSL or cable connection is an external modem connection of a modem connected to said at least one network connection.

9. The telecommunication system according to claim 8, which further comprises:
a switching device;
said switching device being connected between said modem and said at least one network connection, and said switching device being connected between the at least two computer devices and said at least one network connection;
said switching device providing for a connection between the telecommunication system and said modem, and said switching device providing for a connection between the at least two computer devices and the telecommunication system.

10. The telecommunication system according to claim 7, wherein said DSL connection is an ADSL connection.

11. The telecommunication system according to claim 1, which further comprises a router to be connected to the at least two computer devices.

12. The telecommunication system according to claim 11, wherein said router has at least one of a DHCP server for automatically issuing IP network addresses or a firewall function.

13. The telecommunication system according to claim 1, which further comprises a radio interface for connecting at least one of the at least two computer devices to the telecommunication system by radio link.

14. The telecommunication system according to claim 13, wherein said radio interface has a card slot connected to said at least one network connection and into which a mobile radio card can be removeably inserted.

15. The telecommunication system according to claim 14, wherein said card slot permits a mobile radio card constructed as a compact flash card to be inserted into the telecommunication system.

16. The telecommunication system according to claim 15, wherein said card slot is a CF II slot.

17. The telecommunication system according to claim 14, wherein the mobile radio card operates in accordance with the DECT standard.

18. The telecommunication system according to claim 14, wherein the mobile radio card operates in accordance with the WiFi standard.

19. A method for operating a telecommunication system, which comprises the following steps:
connecting at least two computer devices to a network connection of the telecommunication system;
transmitting voice data bidirectionally between the telecommunication system and the at least two computer devices, for permitting each of the at least two computer devices connected to the telecommunication system to be operated as a telephone and/or as a fax device; and
allocating at least one separate telephone number to at least one of the at least two connected computer devices.

20. The method according to claim 19, which further comprises operating the network as an ETHERNET network.

21. The method according to claim 19, which further comprises transmitting the voice data transparently.

22. A method for operating a telecommunication system, which comprises the following steps:
connecting a public telecommunication network to at least one connection of the telecommunication system;
connecting a telecommunication terminal to at least one connection of the telecommunication system;
connecting at least two computer devices to at least one network connection of the telecommunication system;
operating the at least one network connection with a control device to transmit voice data bidirectionally between the telecommunication system and the at least two computer devices, for permitting each of the at least two computer devices connected to the telecommunication system to be operated as a telephone and/or as a fax device; and
allocating, with the control device, at least one separate telephone number to at least one of the at least two connected computer devices.
